(19) United States
(12) Patent Application Publication
(10) Pub. No.: US 2007/0102115 A1
(43) Pub. Date: May 10, 2007

(54) Adhesion Between Textile Reinforcing Materials And Rubber

(75) Inventor: Thomas Falke, Hannover (DE)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: JPMORGAN CHASE BANK, N.A., Houston, TX (US)

(21) Appl. No.: 10/550,260

(22) PCT Filed: Dec. 22, 2003
(86) PCT No.: PCT/US03/40872

§ 371 Date: Jun. 28, 2006

Related U.S. Application Data
(60) Provisional application No. 60/436,307, filed on Dec. 23, 2002.

(51) Int. Cl. C08J 5/06

(52) U.S. Cl. 156/335; 156/307.5; 156/325; 156/910; 152/565; 428/296.4

(57) ABSTRACT

The present invention relates to a method for improving direct adhesion between an adhesive activated textile reinforcing material and an activated rubber. Moreover, the invention relates to a coating composition, a yarn, cord or fabric manufacturing process, a textile reinforcing material obtainable from said method having increased adhesion to rubber and a reinforced rubber article having improved dynamic fatigue properties.

This application claims benefit of priority from U.S. Provisional Application No. 60/436,307 filed Dec. 23, 2002.

### FIELD OF THE INVENTION

The present invention relates to a method for improving direct adhesion between a textile reinforcing material, e.g., an adhesive activated polyester yarn or cord and an activated rubber. Moreover, the invention relates to a coating composition, a yarn, cord or fabric manufacturing process, a textile reinforcing material obtainable from said process having increased adhesion to rubber, and a reinforced rubber article having improved dynamic fatigue properties.

### BACKGROUND OF THE INVENTION

A tire is a highly engineered composite designed to provide safety and durability. Tires, in particular automotive tires for cars, trucks, or aircrafts, undergo significant dynamic and static stresses and strains in the course of ordinary service life. Performance is a major requirement in this product application due to ramifications of failure while in use. In order to obtain the necessary performance characteristics with regard to the proper functioning of a tire, structural reinforcement like polyester, nylon, or rayon having a dtex 1100-4400 is a required component of the tire composite. This reinforcement provides many functions in a tire application, in particular overall strength, dimensional stability for the tire and a mechanism to handle stress dissipation during operation (fatigue). Currently, there is a well established set of products/processes to provide the reinforcing material used in passenger car and truck tire applications.

In order to use textile cords as reinforcing materials, the textile cords are treated with suitable adhesion promoters. It is a particularly noteworthy fact that, for over more than 70 years, bonding fabric to rubber with an aqueous dispersion of a resorcinol-formaldehyde-latex (RFL) is still used. Additionally, a wide spectrum of choices of resin catalyst (usually caustic soda and ammonia), in situ and pre-formed resins, molar ratios of formaldehyde/resorcinol (F/R), resin/latex solids ratio, and adhesion-promoting additives is known. The difficulty in bonding polyester fibers to rubber is generally attributed to the presence of only hydroxyl (OH) and carboxyl (COOH) groups at the ends of the polyester molecules, while in nylon (for example) there is a relatively high frequency of amide (CONH) groups along the macromolecular chain. Therefore, this invention is primarily directed to polyester materials, and most particularly to adhesive-activated (AA) polyester fibers in cords, woven, knitted and non-woven fabrics used to reinforce conveyor belts, tires and hose.

Many adhesives and bonding systems (“dips”) have been used for fabrics made from synthetic linear polyester yarns. Common systems like glycidyl ethers, phenolic condensates and blocked (or free) polyisocyanates are cost-ineffective and additionally suffer from various other disadvantages like precipitation and instability in baths in which fabrics are dipped. Usually, fiber producers pretreat the yarn with finish chemicals (e.g. silanes). Therefore, the resulting adhesive activated (AA) yarns provide an enhanced adhesion with a final adhesion system. This final adhesion system is most often based on RFL (Resorcinol-Formaldehyde-Latex). The adhesion surface on the cord is applied by dipping in dispersions of RFL. Adhesion between cord and rubber is then achieved during curing of the rubber.

Two examples of attempts to improve the adhesion of polyethylene terephthalate filaments to rubber are set forth in U.S. Pat. Nos. 3,297,467 and 3,383,242. In these patents, polyethylene terephthalate filaments are treated with a spin finish which is an aqueous dispersion containing a polyglycidic ether of an acyclic hydrocarbon substituted by at least three hydroxyl groups or a diglycidic ether of an aliphatic diol, respectively, in combination with an amine curing agent and a lubricating agent. After heat treatment to bind the ether and amine components, the filaments or cord made therefrom can then be treated with an adhesive such as RFL. These filaments are known as adhesive activated (AA) yarns.

U.S. Pat. No. 3,297,468 describes a similar finish except that the polyglycidic ether is of a cyclic hydrocarbon substituted with at least two hydroxyl groups.

Another example of an epoxide finish additive which may be employed to promote adhesion between a tire cord and an RFL adhesive is disclosed in U.S. Pat. No. 3,803,035. The finish comprises a lubricating oil, an antistatic agent, an emulsifier and a polyepoxide. Suitable antistatic agents include quaternary ammonium and pyridinium cationic agents.

U.S. Pat. Nos. 3,911,422 and 3,968,304 are directed to a method of bonding polyester tire cords to rubber by use of a two-step process. In the first step, a dip is employed which comprises a low molecular weight polyallyl-glycidyl ether in an aqueous media. In the second step, a dip is employed comprised of an alkaline aqueous dispersion of a rubbery vinyl pyridine copolymer and a heat reactable resinous composition.

Also see U.S. Pat. No. 4,348,517 wherein the same epoxy ether silane is combined with the triglycidyl ether of a glycerol and a defined diglycidyl ether and is used as a fiber finish for an AA polyester yarn.

U.S. Pat. No. 3,793,425 also describes a process for improving the adhesion of polyester material to rubber. In the process, undrawn polyester yarn is coated with a composition containing an epoxy resin which is preferably buffered with an alkaline agent, such as sodium carbonate, lithium carbonate, potassium carbonate or ammonium hydroxide. The use of epoxy resins with alkaline catalysts as spin finishes to produce AA yarns in order to improve the adhesion of polyester to rubber is further disclosed in U.S. Pat. No. 3,423,230 and U.S. Pat. No. 3,464,878.

A process for treating chemically stabilized polyester material to improve the adhesion of the polyester to rubber is also described in U.S. Pat. No. 4,751,143. As noted therein, the aging period for chemically stabilized, adhesive activated polyester material can be reduced by contacting the material before it is substantially drawn or stretched with a composition containing a defined epoxide compound catalyzed with ions of at least one of potassium, cesium, or rubidium at a pH of between about 7.5 to about 13.0. The application of finishes to the polymer surface generally produces a temporary surface condition such as lubrication or electrostatic charge dissipation which may be removed when the surface is subsequently exposed to multiple processing steps. Additionally, polyester surface modifications of the prior art to produce AA yarns employing epoxies to improve the adhesion of polyester to rubber for example, have resulted in the use of a high level of chemical pick-up. Other approaches employed in art to adjust the characteristics or properties of organic polymer surfaces include electrolytic and plasma treatments. However, these processes are costly and have limited processing rates. The application of a strong acid or base has not been particularly effective in modifying surfaces and can penetrate beyond the surface, particularly in fiber structures, to cause strength loss. Polyisocyanates have been employed to enhance adhesion in the manufacture of polyester yarns (see U.S. Pat. No. 3,549,740). These materials have been applied at relatively high concentration levels (greater than 0.5%) and so generate obnoxious vapors, produce deposits on process rolls, and bond filaments to filaments in the yarn bundle. Similar processing problems are encountered in the application of known polyester adhesives such as those based upon resorcinol-formaldehyde resins described in U.S. Pat. No. 3,660,202 and U.S. Pat. No. 3,318,750.

U.S. Pat. No. 4,078,115 discloses an adhesive system for bonding polyester filaments to rubber in which a first coating is employed comprised of the reaction product of a polyepoxide and a quaternized copolymer of 4-vinylpyridine and an aminimide. A second coating of an RFL adhesive is also employed.

Canadian published patent application 652,487 discloses a two coat adhesive system. One coat is a composition comprising triallyl cyanurate, the other a composition comprising vinyl pyridine copolymer RFL. The triallyl cyanurate is polymerized prior to bonding to the cord.

U.S. Pat. No. 3,318,750 also discloses a two coat system. One coat is an aqueous solution of the reaction product of an aldehyde and a composition derived from the reaction of an unsaturated aliphatic ester of cyanuric acid and resorcinol, the other being a RFL dispersion. Optionally the second component can be just the rubbery copolymer latex. The total solid coating is 2% to 7%. This coating is cured, and the cord embedded in rubber and vulcanized.

U.S. Pat. No. 3,419,463 and U.S. Pat. No. 3,419,464 also use a reaction product of resorcinol, triallylcyanurate and formaldehyde (“N-3”) as part of their adhesive system.

JP 50-104104 discloses the use of triallyl isocyanurate to modify the RF resin.

United States published patent application US 2003/0166743 A1 discloses an improved Hexamethylene-Resorcinol (HR) method for direct bonding of polyester cords in rubber. The rubber is activated by compounding hexamethylenetetramrine or hexamethoxymethyl melamine with resorcinol. The polyester yarns are adhesive activated using a spin finish and an over finish containing epoxy functionalities. The adhesive interaction is due to a cross linking between the epoxy groups and the activated rubber. In one example the epoxy adhesive activated cord was coated with a resorcinolic resin. A 5% coating pick up was required to give adequate adhesion.

The application of RFL requires considerable expenditure and costs. The cords are for example treated at high temperatures to cure the adhesive coating which leads to the consumption of a lot of energy; furthermore an additional process step for the production of tires is needed. In addition this high temperature thermal treating process is used to control the balance of treated cord physical properties such as strength, modulus and shrinkage.

In order to improve the adhesion further, adhesion promoters are added to the rubber in addition to the RFL.

It is known from the literature that by using a suitable adhesion promoter in sufficient amounts in the rubber formulation, adhesion of cords to the rubber can be achieved without applying RFL (direct cord/rubber adhesion). A major disadvantage of this method is the large amount of adhesion promoter needed to achieve the desired effect. As a consequence, the rubber properties are determined to a large extent by the properties of promoter. Furthermore, the large amounts of adhesion-promoters to be used constitute a significant expense factor.

### OBJECTS AND SUMMARY OF THE INVENTION

It is a primary object of the present invention to provide an easily applicable and less material consuming method to achieve direct coating to a textile reinforcing fiber during the yarn processing steps. This makes the conventional dipping process as a separate manufacturing step unnecessary.

It is a second object of the present invention to provide a topcoat composition which leads to an increased adhesion of the coated textile reinforcing material and the rubber compared to the non-coated textile reinforcing yarn.

It is a third object of the present invention to provide a textile reinforcing material having increased adhesion to rubber.

It is a fourth object of the present invention to provide a reinforced rubber article having improved dynamic fatigue properties.

The method according to the invention provides improved adhesion between a textile reinforcing material, e.g., the textile cord or a reinforcing member, and the rubber of a reinforced article, e.g., a tire, hose, V-belt or a conveyor belt.

Moreover, the method according to the invention leads to a reduction of production expenditure, since a pretreatment of the polyester yarn by dipping it into adhesion promoters as a separate step in manufacturing, in addition to the elimination of the heat treatment step, is rendered redundant.

In a first embodiment the present invention relates to a method of achieving direct adhesion between a textile reinforcing material and a rubber comprising the steps of
(A) applying a topcoat composition to the adhesive activated (AA) textile reinforcing material;
(B) fixing the topcoat composition to the material obtained from step (A);
(C) embedding the material from step (B) in the rubber; and
(D) curing the rubber containing the polyester reinforcing material obtained from step (C) at a temperature and for a time sufficient to cure said rubber.

In a second embodiment the present invention relates to a coating composition for imparting adhesion to textile reinforcing materials said composition comprising
(i) at least one hydroxyl aromatic compound having at least two hydroxyl groups, or
   a phenolic resin compound obtainable from a hydroxyl aromatic compound having at least one, preferably at least two hydroxyl groups; and
(ii) at least one diene polymer.
   In a preferred embodiment said composition comprises
(i) the at least one hydroxyl aromatic compound having at least two hydroxyl groups, or
   a phenolic resin compound obtainable from a hydroxyl aromatic compound having at least one hydroxyl group, preferably at least two hydroxyl groups,
   dissolved in a suitable solvent, such as, for instance, water; and
(ii) the diene polymer in the form of a latex.
   It is preferred for both embodiments above that the dry weight ratio of (i)/(ii) is about 50/50 to about 80/20, based on the total dry weight of (i) and (ii).

In a third embodiment the present invention relates to an adhesive activated textile reinforcing material obtainable by a method comprising the steps of
(A) applying a topcoat composition to a textile reinforcing material; and
(B) fixing the topcoat composition to the material obtained from step (A).
   The textile reinforcing material obtainable from the method according to the present invention has increased adhesion to activated rubber.

In a fourth embodiment the present invention relates to a reinforced rubber article obtainable by a method comprising the steps of
A) applying an topcoat composition to a textile reinforcing material;
(B) fixing a topcoat composition to the material obtained from step (A);
(C) embedding the material from step (B) in an activated rubber; and
(D) curing the rubber containing the reinforcing material obtained from step (C) at a temperature and for a time sufficient to cure said rubber.
   The reinforced rubber articles according to the present invention have improved dynamic fatigue properties.

Preferred and alternative embodiments become apparent from the description which follows and the dependent claims to which they are explicitly referred.

In contrast to the prior art, it has been surprisingly found that improved adhesion between conventional adhesive activated textile materials and conventional activated rubbers has been achieved without using conventional resorcinol formaldehyde resins and conventional processes such as dipping and heat treating.

### DETAILED DESCRIPTION OF THE INVENTION

According to the invention the textile reinforcing material can be selected from the group consisting of polyesters, rayon, polyamide, and aramid. Polyesters, rayon, polyamides, and aramids, methods of making them and filaments, yarns, cords, fabrics, films, tapes, etc. thereof and methods of adjusting their properties are generally known in the art.

In one embodiment, according to the present invention suitable polyesters may be any highly polymeric linear polyester obtained by heating one or more glycols of the series HO(CH₂)ₙ OH, wherein n is greater than 1, but does not exceed 10 and preferably is between 2 and 8, and more preferably between 2 and 4, with one or more dicarboxylic acid(s), preferably aromatic dicarboxylic acids containing 8 to 16 carbon atoms, more preferably 8 to 12 carbon atoms. Typical examples are selected from the group consisting of naphthalene dicarboxylic acid, 4,4′-diphenyl dicarboxylic acid or, preferably terephthalic acid, or an ester forming derivative thereof. Examples of ester forming derivatives of dicarboxylic acids are their aliphatic (including cyclo-aliphatic) and aryl esters and half-esters, their acid halides and their ammonium and amine salts. Typical, examples of glycols are ethylene, trimethylene, tetramethylene, hexamethylene and decamethylene glycols.

Additionally, the polyester may be reacted or blended with compatible compounds or polymers which do not substantially adversely affect the characteristics of the polyester. For example, compounds yielding non-ester linkages can be added into the reaction mixture for the polyester or pigments, fillers, anti-oxidants, etc. can be blended with the polyester. The preferred polymer for purposes of this invention will be composed of at least 85%, preferably 95% polyethylene terephthalate (PET) or polyethylene naphthalate (PEN) and will most preferably be substantially all polyethylene terephthalate or polyethylene naphthalate.

The material into which the polyester is formed can be any size and configuration amenable to processing which will undergo adhesive activation. The material can therefore be filaments, yarns, cords, fabrics, tapes or films. Preferably, the material is filament or yarn that is melt spun and quenched, particularly those intended for adhesion to rubber as in the production of tires. Illustrative of such polyester material is multifilament polyethylene terephthalate yarn, which is highly crystalline and highly orientated.

The preparation of such high crystalline and highly orientated yarn is, for example set forth in U.S. Pat. No. 4,414,169. An alternate process for preparing multifilament polyethylene terephthalate yarn is set forth in U.S. Pat. No. 4,195,052.

The polyester material used in the present invention may or may not be chemically stabilized. Under typical preparation conditions, a polyester, such as polyethylene terephthalate, has a level of carboxyl end groups ranging from about 30 to 40 microequivalents per gram. To obtain chemical stabilization of the polyester, a compound such as ethylene carbonate, phenyl glycidyl ether, or preferably ethylene oxide, is incorporated into the polyester material. For example, ethylene oxide can be added to a polyester melt which is maintained at a pressure of from about 3,548 kPa to about 35,480 kPa in accordance with the disclosures of U.S. Pat. No. 4,016,142 and 4,442,058.

The term “filament” or “fiber”, as used herein, refers to the components which make up a yarn.

The term “yarn”, as used herein, is a generic term for a continuous strand of fibers, or filaments.

The term “cord” as used herein refers to a plurality of polyester filaments or yarns twisted together to form a single string or reinforcement element. In one illustrated embodiment, the cord comprises 2 to 3 yarns, has a linear density of dtex 2200 to 8800, a twist multiplier of 2.0-7.5 (turns per meter/✓?dtex).

The cord of the invention is preferably made of polyester such as polyethylene terephthalate (PET) or polyethylene naphthalate (PEN).

The polyester yarns applied in the present invention are preferably adhesive activated yarns having high-modulus-low-shrink (HMLS) properties. Such yarn having a high modulus, preferably have less than 5% elongation at a load of 40 cN/tex . They are manufactured by high speed spinning followed by applying a finish comprising epoxy-compounds as described in GB-A-1012935, EP-A-0420333 and U.S. Pat. No. 3,775,150 or halohydroxy compounds as described in U.S. Pat. No. 5,328,765. Afterwards the yarn is drawn and heat-treated.

As mentioned above, alternative textile reinforcing yarns are adhesive activated high tenacity viscose rayon, adhesive activated industrial polyamides such as nylon-6, nylon-6,6 and aramids.

(A) Application of the Topcoat

The textile reinforcing material is topcoated by contacting the material, preferably after it has been drawn and/or heat set with a topcoat composition comprising:
(i) at least one hydroxyl aromatic compound having at least two hydroxyl groups, or
   a phenolic resin compound obtainable from a hydroxyl aromatic compound having at least one, preferably at least two hydroxyl group(s),
   preferably in a suitable solvent, such as water; and
(ii) at least one diene polymer.

By phenolic resin compounds obtainable from said hydroxyl aromatic compound having at least one, preferably at least two hydroxyl group(s) there are meant resinous materials which are obtained by a reaction, such as a condensation reaction, of the hydroxyl aromatic compound with a suitable reactant, such as aldehydes and ketones.

In a preferred embodiment the reinforcing material is contacted with the topcoat composition comprising constituents (i) and (ii) in a dry weight ratio (i)/(ii) of about 50/50 to 80/20, based on the dry weight of the topcoat composition, to form an adhesive activated textile reinforcing material.

The diene polymer is defined as a polymer or copolymer made from one or more diene monomers, optionally containing other polymerizable monomers. Preferably, the diene polymer is added to the hydroxyl aromatic compound or phenolic resin compound in the form of a latex. Thus in context with the present invention the term “latex”, “diene latex”, “polymer latex” and “diene polymer latex” are used interchangeably.

In particular, in one embodiment the topcoat composition as applied according to the present invention comprises:
(i) the at least one hydroxyl aromatic compound having at least two hydroxyl groups; and
(ii) the diene polymer latex.
   Preferably, the dry weight-ratio of compound (i) to diene polymer latex (ii) is from about 50/50 to about 80/20, based on the total dry weight of (i) and (ii).

In another embodiment the topcoat composition as applied according to the present invention comprises:
(i) a phenolic resin compound, obtainable by the reaction of a hydroxyl aromatic compound having at least one aromatic hydroxyl group with an aldehyde or a ketone, preferably at an aldehyde (or ketone)/hydroxyl aromatic compound molar ratio of less than about 1.0; and
(ii) a diene polymer latex.
   Preferably, the dry weight-ratio of phenolic resin compound (i) to diene polymer latex (ii) is from about 50/50 to about 80/20, based on the total dry weight of (i) and (ii).

Typically, the topcoat composition as applied according to the present invention comprises:
(i) a phenolic resin compound having a solids content from about 10 to about 100%, preferably from about 15 to about 80%, most preferably about 20%, obtainable by the reaction of a hydroxyl aromatic compound having at least one aromatic hydroxyl group with an aldehyde or a ketone, at an aldehyde (or ketone)/hydroxyl aromatic compound molar ratio of less than about 1.0; and
(ii) a diene polymer latex having a solids content from about 30 to about 50%, preferably about 35 to 45%, most preferably about 40%,
   wherein the dry weight-ratio of resin (i) to diene polymer latex (ii) is from about 50/50 to about 80/20, based on the total dry weight of (i) and (ii).

Throughout this disclosure the aldehyde or ketone is referred to as (F) and the hydroxyl aromatic compound is referred to as (R). The latex is referred to as (L). Thus an RFL topcoat composition designates a composition comprising the (condensation) reaction product of an aldehyde or ketone with a hydroxyl aromatic compound and a diene polymer latex. An RL topcoat designates a composition comprising a hydroxyl aromatic compound and a diene polymer latex. As will be shown hereinafter and in the examples both the RFL and the RL topcoat preferably are aqueous compositions.

In a preferred method the aldehyde (or ketone) (F)/hydroxyl aromatic compound (R) molar ratio is in the range of about 0.2 to about 0.7 or about 0.9, preferably from about 0.3 to 0.6, and most preferably about 0.4.

In a preferred embodiment of the invention the aldehyde is represented by formaldehyde (F) and the hydroxyl aromatic compound is represented by resorcinol (R).

In an alternative embodiment the topcoat composition as applied comprises
(i) a phenolic resin compound obtainable by the reaction of triallyl cyanurates and/or triallyl isocyanurate with a hydroxy aromatic compound, such as, for instance, those mentioned above, e.g., resorcinol (R), then reacting the resulting product with an aldehyde or a ketone, such as formaldehyde (F) and solubilizing it in an aqueous basic solution with a F/R molar ratio of less than about 1; and
(ii) a diene polymer latex,
   preferably at a dry weight-ratio of resin (i) to latex (ii) from about 50/50 to about 80/20, based on the total dry weight of (i) and (ii).

In a particular preferred embodiment the topcoat composition as applied comprises
(i) a phenolic resin compound having a solids content from about 10 to about 100%, preferably from about 15 to about 30%, most preferably about 20% obtainable by the reaction of triallyl cyanurates and/or triallyl isocyanurate with a hydroxy aromatic compound, such as, for instance, resorcinol (R), then reacting the resulting product with an aldehyde or a ketone, such as formaldehyde (F) and solubilizing it in an aqueous basic solution with a F/R molar ratio of less than about 1; and
(ii) a diene polymer latex having a solids content from about 30 to about 50%, preferably about 35 to 45%, most preferably about 40%, preferably at a dry weight-ratio of resin (i) to latex (ii) from about 50/50 to about 80/20, based on the total dry weight of (i) and (ii).

In a preferred embodiment the aldehyde (or ketone) (F)/hydroxyl aromatic compound (such as resorcinol) (R) molar ratio is in the range of about 0.2 to about 0.7 or about 0.9, preferably from about 0.3 to 0.6, and most preferably about 0.4.

Typically, the reaction between the triallyl cyanurate and/or triallyl isocyanurate and the hydroxyl aromatic compound (such as resorcinol) is conducted at high temperatures, such as between about 200 C and about 275° C., preferably between about 220° C. and about 250° C.

The weight ratio of triallyl cyanurate (and/or triallyl isocyanurate) and the hydroxyl aromatic compound is not critical but preferably is between about 1 to 6 and about 1 to 12, most preferably between about 1 to 8 and about 1 to 10.

Generally, the phenolic resin compound contains 2 or more aromatic hydroxyl groups. Preferred classes are condensation products of hydroxyl aromatic compounds condensed with an aldehyde or a ketone with an aldehyde/ketone to phenolic molar ratio of less than 1.0.

Examples of hydroxyl aromatic compounds with 2 or more aromatic hydroxyl groups contain between 5, preferably 6 and 14, preferably 10 carbon atoms. Typical examples are resorcinol, 4,4′-sulfonyldiphenol and 4,4′-oxydiphenol, 1,2-, 1,3-, 1,4-, 1,5- and 1,6-naphthalene diols with resorcinol being preferred. Examples of hydroxyl aromatic compounds which contain at least one hydroxyl group, preferably at least two hydroxyl groups are preferably selected from the group consisting of phenol, chlorophenol, resorcinol, cresol and m-aminophenol, with resorcinol being preferred. Condensation reactions of hydroxyl group containing compounds, such as the hydroxyl aromatic compounds of the invention with aldehydes or ketones are well known in the art.

In conjunction with the present invention, preferred aldehydes contain between about 1 and about 12 carbon atoms, preferably between about 1 and about 7 carbon atoms.

Preferred ketones contain between about 3 and about 8 or about 13 carbon atoms, preferably between about 3 and about 6 carbon atoms. Specific examples of aldehydes and ketones are formaldehyde, furfural, acetaldehyde, glutaraldehyde, benzaldehyde, propionaldehyde, succinaldehyde, acetone, methyletlhylketone and 1,4-cyclohexanedione, with formaldehyde being preferred. Preferred ketones are acetone, etc.

It is important that the aldehyde/ketone to hydroxyl aromatic compound molar ratio is less than about 1.0 so that the resin does not self-polymerize and can penetrate the textile material, such as the yarn or cord.

The solvent for the hydroxyl aromatic compound and the phenolic resin compound is preferably water, and, if necessary, preferably the phenolic resin compound is solubilized with a base. The base can be sodium hydroxide, potassium hydroxide, arumonium hydroxide, tetraethylammonium hydroxide, triethanolamine, diethanolamine, triethylamine, prefer/ably ammonium hydroxide. The base is added in an amount sufficient to solubilize the phenolic compound in the aqueous system.

The topcoat composition may contain other components, like tracers, dyes, emulsifiers, lubricants, etc.

In an alternative embodiment the phenolic resin component can be a resin obtainable from the reaction of triallyl cyanurate, triallyl isocyanurate, or mixtures thereof and the hydroxyl aromatic compound containing at least one hydroxyl group, such as resorcinol at high temperatures, then reacting the resulting product with an aldehyde, such as formaldehyde, and solubilizing the reaction product in an aqueous basic solution, with a F/R molar ratio of less than about 1.0. Suitable resin components (i) containing triallyl cyanurate are well known in the art, e.g. from U.S. Pat. No. 3,419,463 and 3,419,464, under the name “N-3”. The preferred F/R molar ratio is about 0.2 to about 0.7 with a preferred pH in the range of about 8.5 to about 9.3.

The preferred form of the diene polymer in the topcoat composition is an aqueous dispersion, commonly called latex.

The latex component (ii) of this invention should not be considered as being limited to any specific type of synthetic or natural rubber latex, but rather to include all of those comparable diene polymer latex compositions commonly employed in the rubber fabricating industry. It is preferred however, that the latex contains at least some vinyl pyridine latex. This well-known type of latex is formed from butadiene, styrene, and vinyl pyridine monomers, in a preferable weight ratio of about 65-75/10-20/10-20, usually in about a 70/15/15 by weight ratio.

The topcoat composition may further comprise a lubricant, such as butyl stearate, ethoxylated long chain alcohols, ethoxylated polysiloxanes and mixtures thereof, in amounts ranging from about 0 to about 50% by dry weight.

The topcoat composition may also comprise a solvent, such as water, acetone, butyl carbitol, isopropanol, ethanol and mixtures thereof. The preferred solvent is water in an amount ranging from 50 to 99%, preferably 85 to 98% by weight. Water is advantageously employed as the solvent for a composition used as a topcoat.

Other components which may be present in the topcoat composition include tints, fluorescent brighteners, emulsifiers, antifoaming agents, antimicrobial compounds, co-catalysts, co-reactants, dispersion stabilizers, analytical markers, flexibilizers such as methacrylates and mixtures thereof. The total amount of solids (i.e., all constituents except solvent) in the topcoat composition typically ranges from about 1 to about 50% by weight, preferably from about 2 to about 15% by weight.

The topcoat composition can be contacted with the polymeric material using any suitable means which is selected primarily based on the form of the polymeric material. Exemplary means include a metered applicator, a kiss roll, spray or foam. The adhesive imparting topcoat composition is present on the reinforcing polyester material in an amount of from about 0.1 to about 3% by weight, preferably from about 0.2 to about 2% by weight, and most preferably from about 0.4 to about 1.5% by weight, based on the weight of the dry coated adhesive activated polyester reinforcing material. An example of a preferred topcoat composition level is less than about 1%, based on the total weight of the dried coated polyester material, such as a cord or yarn.

Topcoat Fixation (B)

After applying the topcoat composition on the textile reinforcing material, such as the drawn yarn or cord, it is fixed to the material, such as the filaments by heating at temperatures of about 110 to 250° C., preferably from about 110° C. to 240° C., most preferably from about 215° C. to 235° C. Depending on the temperature employed, the time at lower temperatures is several minutes, and at higher temperatures for about 60 seconds or less. Even room temperature aging can achieve fixation, if the time is extended to about 4 days. In a continuous topcoat drying and fixation process it is preferred to heat the yarn to about 235° C. for less than about 30 seconds, and most preferred less than 15 seconds. Optionally, this fixation step can be conducted in the normal treating process.

Cuting Step (C

After fixing the topcoat, the textile reinforcing material is adhered to the rubber. The textile reinforcing material, such as a cord or yarn, is partially or fully embedded in a curable rubber and the rubber is cured for about 6 to 120 min., preferably for about 6 to 15 min., most preferred for about 6 to 10 min. at temperatures of about 140 to 220° C., preferably of about 160 to 200° C., most preferred of about 170 to 180° C.

In a preferred embodiment of the present invention the rubber used is an activated rubber, i.e., a rubber formulation which comprises agents known from the prior art for improving the adhesion to RFL treated cord. Specific examples for said rubber adhesion promoters are resorcinol, hexamethoxymethyl melamine (HMMA), sulfur, sulfenamides, zinc oxide, stearic acid and carbon black. The adhesion promoters are contained in said activated rubber in an amount of between about 0.5 to 5.0 weight parts per hundred weight parts of rubber (phr), preferably between about 1.0 to 4.0 phr.

The term “rubber” as used herein refers to carbon black and/or silica filled natural and synthetic rubber systems, which can be cured so as to exhibit elastomeric properties. For the purpose of this invention the term “elastomer” is used interchangeably with the term “rubber”. Representative synthetic rubbery polymers include the diene polymers. Generally, rubber compositions or compounds utilized herein can be saturated, unsaturated or a combination thereof. Preferably, the rubber compositions and compounds are suitable for use in tire fabrics and related materials. In preferred embodiments, the rubber compositions or compounds comprise at least some degree of unsaturation. Contemplated rubber compounds described herein are natural or synthetic rubbers or are comprised of mixtures containing various natural and synthetic rubbers. None limiting examples of synthetic rubbers are polyisoprene, acrylonitrile-butadiene copolymers, polychloroprene, butyl rubber, ethylene-propylene-diene (EPDM) terpolymers, polybutadiene (which can be modified by hydroxyl groups, carboxylic acid groups and/or anhydride groups), styrene-butadiene copolymers. Diene polymers comprise those polymers having rubber-like properties which are prepared by polymerizing a conjugated C₄ to C₆ diolefin such as butadiene, isoprene chloroprene copolymerized with styrene, methyl styrene and acrylonitrile, the conjugated diolefin usually being present in the mixture to the extent of at least 40% —based on the total of polymerizable material —and preferably in major portion. The butadiene-styrene copolymers are manufactured commercially under such names as SBR 1000, SBR 1006, SBR 1500 and 1502. Example of typical rubbers are selected from the group consisting of diene rubbers, diene/alpha-olefin rubbers, ethylene/propylene rubbers and ethylene/alpha-olefin/diene rubbers (EPDM).

Other synthetic rubbers include the “neoprene” rubbers. “Neoprene” is a generic name which is applied to polymers of chloroprene, and copolymers of chloroprene with dienes or vinyl compounds, in which the chloroprene comprises the predominant monomer. An isobutylene-isoprene copolymer “Butyl” rubber, as well as the elastomeric ethylene-propylene copolymers and terpolymers may also be used.

The term “cured” is used interchangeably with the term “vulcanized” in conjunction with the cured rubber component of this invention denotes that the rubber component to be vulcanized has been cured to a state in which the physical properties of the rubber are developed to impart elastomeric properties to the rubber generally associated with the rubber in its conventional vulcanized state.

The rubber employed may contain customary amounts of various additives such as those needed to effect or accelerate vulcanization. Examples of such materials include sulfur, sulfur chloride, sulfur thiocyanate, thiuram polysulfides, sulfenamides, sulfenamides, thiosulfenamides and other organic or inorganic polysulfides. These components are preferably employed in amounts varying from about 0.1 to 10% and preferably from 0.3 to 3% of rubber.

Many other materials may also be included in the rubber composition such as pigments, antioxidants, silica, sulfur, rubber curing initiators, accelerators, oils, antidegradants and other reinforcing fillers and the like, all in accordance with practices well known in the art.

This invention is not limited to sulfur cured rubbers, but may also be applied to rubbers cured by cross-linking with free radical initiators, e.g. peroxides.

All standard state of the art RFL resins have a F/R molar ratio of greater than 1.0. For instance, U.S. Pat. No. 3,775,150 studied the impact of F/R molar ratio on adhesion and teaches that for adhesive activated polyesters yarns the range should be 1.2 to 1.8. According to the present invention it was surprisingly found that by using an aldehyde/ketone to phenolic molar ratio of less than 1.0, preferably in the range 0.2 to 0.7, the uncondensed phenolic resin improves the adhesion to activated rubbers. Although not wishing to be bound by any theory, it is believed that the uncondensed phenolic resin diffuses further into the polyester surface.

Formaldehyde donors and other ingredients in the activated rubber such as HMMA then diffuse into the phenolic resin during the curing step to complete the polymerization of the phenolic resin. These mechanisms provide a stronger bond between the polyester/phenolic resin-latex/rubber interfaces. Adhesion is improved, without interfilament bonding, even when the topcoat is applied to yarn. This gives a less stiff cord and improved dynamic fatigue performance.

This is in contrast with the HR direct bonding approach of US 2003/0166743 A1 in which there is cross linking of the outer filaments of the adhesive active polyester cord with the activated rubber resulting in a stiff cord.

The following Examples are given as illustrations of the invention. It should be understood, however, that the invention is not limited to the specific details set forth in the Examples. Throughout this disclosure and in the examples which follow all percentages indicated refer to percent by weight (%), unless otherwise specified.

### EXAMPLES

Commercial HMLS tire yarns from KoSa were used for the Examples. Type 792 is a non-adhesive activated yarn, Type 793 is an adhesive activated (AA) (halohydroxy based) yarn and Type 748 is another adhesive activated yarn (epoxy based).

The topcoat composition (N3-L) used, unless otherwise stated, in the examples was a 12.4% dispersion made from:
11.5% Gentac 118® (70% butadiene/15% styrene/15% vinylpyridine terpolymer) from Omnova Solutions Inc., Fairlawn Ohio, USA (41% solids in water);
34.1% N3® from FCI Technology Inc. Bessemer City, N.C., USA or N3 from Omnova Solutions Inc., Fairlawn, Ohio, USA sold as HP resin (22.5% solids in water); and 54.4% Water.

The yarns or cords were topcoated to a total level of topcoat on yarn, unless otherwise stated, of 1.0% on a dry weight basis. The N3 resin has a F/R molar ratio of 0.38.

The topcoated yarns or cords were heated at 229° C. for 60 seconds, unless otherwise stated. The rubber compounds used in the examples were Compound A, a non-activated rubber formulation of a blend of natural rubber, butadiene rubber and styrene-butadiene rubber, and Compound B an activated rubber of a blend of natural rubber and styrene-butadiene rubber with a RF-adhesion system of resorcinol and resorcinol-formaldehyde precondensate, a methylene donor and active silica.

Unless otherwise noted, the peel adhesion test was conducted in accordance with ASTM D4393-00. The rubber composite specimens were cured at 170° C. for 10 minutes at 0.75 MPa. The cured test specimens were allowed to cool to room temperature for about 4 hours. The specimens were cut parallel to the cords to a width of 25 mm, and then pre-heated to 120° C. for 30 minutes and the peel test initiated within 30 seconds after removal from the oven. The tensile tester crosshead speed was 100 mm per minute, with a gauge length of 40 mm. A peel adhesion visual rating scale was used with 0 representing zero rubber coverage and 5 representing 100% rubber coverage, rubber coverage was judged to the nearest 12.5%.

Unless otherwise noted, the pull-out adhesion was conducted in accordance with ASTM D2229-99. The embedded cord length is 5 mm with a cord to cord distance of 15 mm. The rubber composite specimen is first cured at 170° C. for 10 minutes, and allowed to cool down to room temperature for about 4 hours. The specimens were then preheated at 150° C. for 30 minutes and tested within 30 seconds from removal from the oven.

### Example 1

1440 dtex Type 792 and 793 yarns were twisted into a 2 ply cord with 420 turns per meter (tpm). These cords were topcoated with N3-L and the topcoat fixed for 55 seconds at 235° C. and then embedded in both activated and non-activated rubbers and cured at 150° C. for 30 minutes. The force to pull out the cords was measured, and the results set forth in Table 1.

TABLE 1

| Yarn (PET) | Rubber Compound | Pull-out Adhesion (N) |
|---|---|---|
| 792 (non-AA) | A | 15 |
| 792 (non-AA) | B | 25 |
| 793 (AA) | A | 20 |
| 793 (AA) | B | 65-85 |

The results in Table 1 demonstrate that the combination of AA-Yarn and activated Rubber compound B lead to a significant increase of adhesion level. The results of 792 yarn in Rubber A represent the prior art of U.S. Pat. No. 3,318,750.

Only if the rubber contains an adhesion promoter and the polyester yarn is adhesive activated, significant levels of adhesion could be observed in the pull-out test.

In accordance to the present invention it has been observed, that it was sufficient to use a low F/R molar ratio topcoat (on the yarn) and small amounts of a standard adhesion system in the rubber to achieve good adhesion. The topcoat is interacting directly with the rubber without a standard RFL dip.

### Example 2

The adhesion of the inventive system was compared to conventional RFL dipping. 1440 dtex Type 748 and 793 yarns were twisted into 2 ply cords with 420 turns per meter (tpm). These cords were topcoated with N3-L and the topcoat fixed for 55 seconds at 235° C. Fabrics (121 ends per decimeter (epdm)) were prepared from these topcoated Type 793 and Type 748 cords. Both fabrics were then embedded in activated rubber compound B. A third fabric was prepared from Type 793 cord without topcoat, and then embedded in activated rubber compound B. A fourth fabric was prepared from Type 793 cord without topcoat, but dipped in a standard RFL (F/R molar ratio of 1.2) composition with a 5% dip pick-up and cured. This fourth fabric was then embedded in activated rubber compound B. The four rubber composites were cured for 10 min. at 177° C. The peel adhesion of these composites is set forth in Table 2.

This example shows that the rubber composite obtained from topcoated cords has equivalent adhesion forces compared to rubber composites obtained from standard RFL dipped cords. In addition, the topcoated samples show a significant adhesion improvement compared to the non-topcoated sample.

TABLE 2

| Yarn in Fabric | Adhesive System | Peel Adhesion Force (N) |
|---|---|---|
| 793 | None | 65-98 |
| 793 | N3-L topcoat | 135-152 |
| 793 | RFL dip | 132-178 |
| 748 | N3-L topcoat | 145-159 |

### Example 3

The fabrics for Example 2 were used to build 205/60 R15 tires. The peel adhesion of sections cut from the sidewalls was measured and the results set forth in Table 3.

TABLE 3

| Yarn in Fabric | Adhesive System | % Rubber Coverage | Adhesion (N) |
|---|---|---|---|
| 793 | None | 0 | 38-46 |
| 793 | N3-L topcoat | 10 | 42-54 |
| 793 | RFL dip | 70 | 53-60 |
| 748 | N3-L topcoat | 80 | 72-81 |

Table 3 shows the in-tire adhesion performance of calendered carcass fabrics. With the activated rubber B skim compound, the cured tire shows, under equivalent curing conditions, that topcoated and RFL dipped carcass sections show equivalent adhesion performance, and low adhesion values in the case of tires built with non-topcoated 793. This non-topcoated 793 fabric is representative of the HR bonding system of prior art US 2003/0166743 A1. Best results for rubber coverage shows in tire cord fabric manufactured with topcoated 748 (Adhesive Activated) yarn.

High speed, endurance and durability in the flexing zone showed no difference between the topcoated and RFL dipped fabrics in testing of these tires.

### Example 4

The effect of the curing conditions on the final adhesion (pull-out force) between rubber and cord was measured using topcoated cords from Example 2, and the results set forth in Table 4. As is evident from the results, longer curing-times and higher temperatures are beneficial to achieve higher adhesion. Preferably, curing temperatures of 160 to 200° C. are applied, the cure time may be varied between 6-120 min.

TABLE 4
Pull-out Adhesion (N)

| | Curing Conditions (in Rubber Compound B) | | | | | | |
|---|---|---|---|---|---|---|---|
| | 30 min | 8 min | 12 min | 15 min | 8 min | 12 min | 15 min |
| Yarn | @150° C. | @170° C. | @170° C. | @170° C. | @180° C. | @180° C. | @180° C. |
| 793 | 34 | 33 | 53 | 65 | 44 | 54 | 55 |
| 748 | 45 | 43 | 73 | 78 | 70 | 92 | 86 |

### Example 5

The N3-L topcoat was applied at various stages of the process:
A) Yarn topcoated and then twisted into 2-ply cord
B) Yarn twisted into a single ply, topcoated and twisted into 2-ply cord
C) Cord topcoated

The cords were fixed, embedded in activated rubber compound B and cured. The peel force of the cured rubber was measured and the results set forth in Table 5.

TABLE 5

| Application process | Yarn Type | Peel Adhesion (N) |
|---|---|---|
| A | 793 | 30 |
| B | 793 | 40 |
| C | 793 | 62 |
| A | 748 | 72 |
| B | 748 | 30 |
| C | 748 | 93 |

The preferred method for applying the topcoat is either at the yarn or cord stage.

### Example 6

1440 dtex Type 748 yarns were topcoated to a 0.6 dry % of N3-L on yarn, and fixed for 11 seconds at 220° C. The formula of N3-L was the same as that given preceding example 1, but diluted with more water to a 3.75% N3-L concentration. The yarns were twisted into 2-ply cords at a low twist level of 250 tpm. Control cords from the same yarn were prepared at different twist levels and dipped in a standard RFL (1.2 F/R molar ratio) dip composition with a 5% dip pick-up and cured in a treating oven. These cords were embedded in the activated rubber compound B and cured at 150 C for 30 minutes.

Visual inspection of the cords after a peel adhesion test showed excellent adhesion of the cords (visual ratings of 4.5 to 5).

The embedded cords were subjected to a dynamic fatigue test (Disc fatigue test ASTM D6588-02), and the strength of the cords measured after 3.6 and 10.6 million cycles.

The results are set forth in Table 6 below.

TABLE 6

| | | Retained strength, % | |
|---|---|---|---|
| | Twist level | (Number of cycles) | |
| Adhesion System | (Turns/meter) | 3.6 million | 10.6 million |
| RFL dip | 370 | 100 | 94 |
| RFL dip | 310 | 92 | 82 |
| RFL dip | 250 | 75 | 47 |
| N3-L topcoat | 250 | 95 | 70 |

This demonstrates the superior dynamic fatigue of the inventive system, and will allow lower twist levels to be used in rubber composites.

### Example 7

1440 dtex Type 748 yarns were topcoated with various levels of N3-L. The formula of N3-L was the same as that given preceding example 1, but diluted with more water to the concentrations of dry topcoat in water given in the table below. Levels were applied by metering a known concentration of aqueous dispersion of topcoat onto a known weight of yarn as it passed across the metered applicator. The wet topcoated yarns were dried by passing them through a tubular oven at 300° C. for 2.8 seconds. Then the yarns were heat-set for 20 seconds in a hot air oven at 235° C. The yarns were twisted into 2-ply cords at a twist level of 250 tpm. These cords were embedded in the activated rubber compound B and cured at 170° C. for 10 minutes.

The peel adhesion results are set forth in Table 7.

TABLE 7

| Target dry | Concentration in | | |
|---|---|---|---|
| topcoat level | water of topcoat | Peel adhesion | Peel adhesion |
| (%) | applied (%) | force (N) | visual rating |
| 0.80% | 5.04 | 139 | 3.0 |
| 0.60% | 3.71 | 141 | 3.0 |
| 0.40% | 2.54 | 122 | 3.0 |
| 0.20% | 1.25 | 119 | 2.0 |

Visual inspection of the cords after a peel adhesion test showed excellent adhesion of the cords at levels above 0.4% topcoat on yarn.

### Example 8

1440 dtex Type 748 yarns were topcoated with topcoats made of N3 and various latices. Target ratio of dry weights of N3 resin to latex was 62/38. The table 8 describes the composition of the topcoats used.

Gentac 165 (a terpolymer of butadiene, styrene and 10% vinyl pyridine) and Gentac 118 (Omnova Solutions Inc., Fairlawn, Ohio, USA)

Pliocord SB2108 (a butadiene and styrene copolymer) (Eliokem, Villejust, France).

TABLE 8

| | | | | Weight |
|---|---|---|---|---|
| | | | Weight of | of 22.5% |
| | | Weight of | deionized | active |
| | | latex used | water used | N3 used |
| Topcoat | Latex used | (grams) | (grams) | (grams) |
| A | Gentac 165 (45% | 4.22 (as 45% | 82.01 | 13.77 |
| | active) | active) | | |
| B | Gentac 165 (45% | 2.11 (as 45% | 81.80 | 13.77 |
| | active) Pliocord SB | active) 2.32 (as | | |
| | (40% active) | 40% active) | | |
| C | Pliocord SB 2108 | 4.63 (as 40% | 81.60 | 13.77 |
| | (40% active) | active) | | |
| D | Gentac 118 (41.8% | 4.63 (as 41.8% | 81.60 | 13.77 |
| | active) | active) | | |
| E | No topcoat used | none | none | none |

The latex was stirred and the water added while stirring. The N3 was then stirred in to the water/latex mixture.

The target level of topcoat was applied by metering the known concentration of aqueous dispersion of topcoat onto a known weight of yarn as it passed across the metered applicator. The target level of topcoat throughout this example was 0.8% by weight of dry topcoat on yarn. The wet topcoated yarns were dried by passing them through a tubular oven at 250° C. for 1.4 seconds, then wound onto bobbins. Then the yarns were heat-set for 30 seconds in a hot air oven at 235° C. The yarns were twisted into 2-ply cords at a twist level of 300 tpm. These cords were embedded in the activated rubber compound B and cured at 170° C. for 10 minutes.

The peel adhesion results set forth in Table 9.

TABLE 9

| | | | Peel |
|---|---|---|---|
| | % Vinyl pyridine in latex | | Appearance |
| Topcoat | part of topcoat | Peel Force (N) | (visual rating) |
| A | 10 | 140 | 4.0 |
| B | 5 | 160 | 4.5 |
| C | 0 | 140 | 3.0 |
| D | 15 | 121 | 3.5 |
| E | No topcoat | 95 | 4.0 |

The results show that a wide range of vinyl pyridine content in the latex gives good adhesion.

### Example 9

1440 dtex Type 748 yarn was topcoated with topcoats made of Gentac 118 latex and various modifications of N3 resin. The resin of topcoat F was prepared to the standard composition shown in U.S. Pat. No. 3,318,750. Resins G & H were prepared in the same way, with the exception that the amount of formaldehyde was either increased in cell G or decreased in cell H. The target ratio of dry weights of resin to latex was 62/38. Table 10 describes the composition of the topcoats used. All resins were obtained from Omnova Solutions Inc., Fairlawn Ohio, USA. The resin of topcoat F is sold by Omnova as HP Resin.

TABLE 10

| | | | | | Weight |
|---|---|---|---|---|---|
| | | | | | of |
| | | | | | 22.5% |
| | Weight of | Weight of | | Formaldehyde | active |
| | Gentac 118 | deionized | | to resorcinol | resin |
| | latex used | water used | Resin | molar ratio in | used |
| Topcoat | (grams) | (grams) | used | resin | (grams) |
| F | 4.63 | 81.60 | standard | 0.38 | 13.77 |
| | | | N3 | | |
| | | | resin | | |
| G | 4.63 | 81.60 | Modified | 0.60 | 13.77 |
| | | | N3 | | |
| | | | resin | | |
| H | 4.63 | 81.60 | Modified | 0.19 | 13.77 |
| | | | N3 | | |
| | | | resin | | |
| I | none | none | none | | none |
| (no | | | | | |
| topcoat) | | | | | |

The latex was stirred and the water added while stirring. The resin was then stirred in to the water/latex mixture.

The target level of topcoat was applied by metering the 5% concentration of aqueous dispersion of topcoat onto a known weight of yarn as it passed across the metered applicator. The target level of topcoat throughout this example was 0.8% by weight of dry topcoat on yarn. The wet topcoated yarns were dried by passing them through a tubular oven at 250° C. for 1.4 seconds, then wound onto bobbins. Then the yarns were heat-set for 30 seconds in a hot air oven at 235° C. The yarns were twisted into 2-ply cords at a twist level of 300 tpm. These cords were embedded in the activated rubber compound B and cured at 170° C. for 10 minutes.

The peel adhesion results set forth in Table 11.

TABLE 11

| | F/R molar ratio in the N3 | | Peel Appearance |
|---|---|---|---|
| Topcoat | resin | Peel Force (N) | (visual rating) |
| F | 0.38 | 144 | 4.0 |
| G | 0.60 | 131 | 4.0 |
| H | 0.19 | 150 | 4.0 |
| I | No topcoat | 95 | 4.0 |

The results show that all molar ratios of formaldehyde to resorcinol that were tested, gave good adhesion.

### Example 10

1440 dtex Type 748 yarn was topcoated with N3-L topcoat from a 5% aqueous emulsion. The target level of topcoat was applied by metering the known concentration of aqueous dispersion of topcoat onto a known weight of yarn as it passed across the metered applicator. The target level of topcoat throughout this example was 0.8% by weight of dry topcoat on yarn. The wet topcoated yarns were dried by passing them through a tubular oven at 250° C. for 1.4 seconds, then wound onto steel bobbins. The yarn temperature as it exited the hot tube was in the range of 110° C.-150° C., indicating that all the water had been driven off. The bobbins were placed in convection ovens at different temperatures for 24 hours, and then twisted into 2-ply cords at a twist level of 300 tpm. A control topcoated cord was heat-set for 30 seconds at 235° C., instead of the 24 hours at 80-120° C. These cords were embedded in activated rubber compound B and cured at 170° C. for 10 minutes.

The peel adhesion results are set forth in Table 12.

TABLE 12

| | | | Peel Appearance |
|---|---|---|---|
| Sample | Oven temperature (° C.) | Peel Force (N) | (visual rating) |
| J | 80 | 131 | 3.0 |
| K | 100 | 142 | 3.0 |
| L | 120 | 101 | 1.5 |
| M | control | 134 | 3.0 |

The results show that low topcoat fixation temperatures for long times can give good adhesion.

### Example 11

N3-L topcoat was prepared as in Example 1, with more water, making 5.2% concentration. The pH was 8.9.

1440 dtex Type 748 yarn was topcoated to a target level of 0.80% dry topcoat on yarn by means of two metered applicators. The wet topcoated yarn was dried in line by passing it through a hot air oven at 250° C. for 1.3 seconds, then wound onto a tube. The yarn was in the temperature range of 143° C.-153° C. as it exited the hot tube. No further heat treatment was given to the yarn. The yarn was then twisted into 2-ply cords at a twist level of 300 tpm. These cords were embedded in the activated rubber compound B and cured at 170° C. for 10 minutes.

The peel adhesion force for this sample was 142 N, with a visual rating of 2.8.

The results show that good adhesion can be obtained with a single dry and fixation treatment of short duration.

1440 dtex Type 748 yarn was topcoated as above to a target level of 0.80% dry topcoat on yarn by means of two metered applicators. The wet topcoated yarn was passed through a tube at room temperature, with room temperature air blowing onto the yarn. The yarn passed through the tube for 1.3 seconds, and then wound onto a tube. The yarn felt damp to the touch. No further heat treatment was given to the yarn. The yarn was then twisted into 2-ply cords at a twist level of 300 tpm. These cords were aged (topcoat fixation) for different times at room temperature, then embedded at 98 epdm in the activated rubber compound B and cured at 170° C. for 10 minutes.

The peel adhesion results are set forth in Table 13.

TABLE 13

| Aging time before | | Peel appearance |
|---|---|---|
| bonding to rubber | Peel force (N) | (visual rating) |
| 4 hours | 143 | 1.5 |
| 8 hours | 131 | 1.5 |
| 24 hours | 141 | 3.5 |
| 48 hours | 132 | 1.5 |
| 96 hours | 136 | 3.8 |
| 21 days | 142 | 4.5 |

The results show that good adhesion can be obtained with by drying and fixing at room temperature for a period of at least 4 days.

### Example 12

N3 resin was made according to the U.S. Pat. No. 3,318,750, with a formaldehyde/resorcinol molar ratio of 0.38. The pH was varied by adding varying amounts of ammonia. The standard amount gives a pH in the range of 8.8 to 9.7. By reducing the ammonia, lower pH was obtained. In addition, the lowest pH topcoat variant was reduced in pH even more by stirring carbon dioxide gas into the aqueous topcoat.

N3-L topcoat was prepared as in example 1, but with more water, making 5% concentration. The topcoats prepared were as shown in Table 14:

TABLE 14

| | pH of N3 | | |
|---|---|---|---|
| | resin | pH of Gentac | pH of 5% N3-L topcoat |
| Sample | used | 118 latex used | applied to yarn |
| O | 8.3 | 10.4 | 8.8 |
| P | 8.3 | 10.4 | 8.5 |
| Q | 9.7 | 10.4 | 9.3 |
| R | 9.2 | 10.4 | 9.0 |

1440 dtex Type 748 yarn was topcoated with topcoats prepared as above. The target level of 0.8% dry topcoat on yarn was applied by metering the known concentration of aqueous dispersion of topcoat onto a known weight of yarn as it passed across the metered applicator. The wet topcoated yarns were dried by passing them through a tubular oven at 250° C. for 1.4 seconds, then wound onto steel bobbins. The bobbins were placed in convection ovens at different temperatures for 24 hours, and then twisted into 2-ply cords at a twist level of 300 tpm. These cords were embedded in the activated rubber compound B and cured at 170° C. for 10 minutes.

The peel adhesion results are given in Table 15.

TABLE 15

| | | | Peel |
|---|---|---|---|
| | | | Appearance |
| Sample | pH of N3-L topcoat | Peel Force (N) | (visual rating) |
| O | 8.8 | 142 | 3.5 |
| P | 8.5 | 146 | 4.0 |
| Q | 9.3 | 126 | 4.0 |
| R | 9.0 | 142 | 4.0 |

The results show that at all pHs good adhesion was achieved, but it is best to keep pH below about 9.3.

### Example 13

N3-L topcoats were prepared with different weight ratios of N3 to Gentac 118 latex. The topcoats were prepared at overall concentrations of 5% with varying weights of the two components. Table 16 shows the weights of components taken in preparing the topcoats.

TABLE 16

| Weight ratio | | Weight of | Weight | Measured |
|---|---|---|---|---|
| of dry | Weight of | 41% | of 22.5% | concentration |
| components, | deionized | Gentac 118 | active | of topcoat by |
| N3/Gentac | water used | used | Omnova HP | evaporation |
| 118 Latex | (grams) | (grams) | used (grams) | of water (%) |
| 62/38 | 163.18 | 9.27 | 27.56 | 5.16 |
| 50/50 | 82.79 | 6.10 | 11.11 | 5.11 |
| 75/25 | 80.28 | 3.05 | 16.67 | 5.18 |
| 87.5/12.5 | 79.03 | 1.52 | 19.44 | 5.19 |
| 100/0 | 77.78 | 0.00 | 22.22 | 5.21 |
| 38/62 | 83.99 | 7.56 | 8.44 | 5.11 |
| 0/100 | 87.80 | 12.20 | 0.00 | 5.07 |

Each topcoat was applied to 1300 denier drawn T-748 yarn by two metered applicators to a target dry applied level of 0.8% on weight of yarn. The wet topcoated yarn was passed through a hot tube for 1.3 seconds to dry the yarn. The yarn exiting the tube was at 130-150° C. The yarn was then wound onto a tube. The yarn was then heat-set in a hot oven (235° C. for 30 seconds with zero stretch) and wound onto a bobbin. The yarn was then twisted into 2-ply cords at a twist level of 300 tpm. These cords were embedded in the activated rubber compound B and cured at 170° C. for 10 minutes.

The peel adhesion results are given in Table 17.

TABLE 17

| Weight ratio of dry | | |
|---|---|---|
| components, | | Peel adhesion |
| N3/Gentac 118 Latex | Peel adhesion force (N) | visual rating |
| 62/38 | 145 | 3.0 |
| 50/50 | 119 | 3.5 |
| 75/25 | 132 | 4.0 |
| 87.5/12.5 | 94 | 3.5 |
| 100/0 | 97 | 2.5 |
| 38/62 | 101 | 4.0 |
| 0/100 | 93 | 4.0 |

The results show that a wide range of weight percentages of N3 give good adhesion-from about 50% N3 to about 80% N3.

### Example 14

A resin of formaldehyde to resorcinol molar ratio of 0.38 was prepared by adding 54.86 grams of distilled water to 16.59 grams of resorcinol and 11.64 grams of 10% sodium hydroxide solution. After a clear solution was obtained, the pH was measured as 8.83. 4.7 grams of 37% formaldehyde solution was added and the container sealed. Stirring at room temperature was done for 2 hours, then left to stand in the sealed container overnight.

A topcoat was prepared by adding to 4.63 grams of Gentac 118. 81.60 grams of deionized water with stirring at room temperature. After about ten minutes of stirring, 13.77 grams of the 0.38 F/R molar ratio resin solution was stirred in. The pH of the topcoat was 8.60 at a concentration of 5.11%. On a dry weight basis, the ratio of resin to latex is 62/38.

The above topcoat was applied to 1440 dtex Type 748 drawn yarn to a target level of 0.80% dry topcoat on yarn by means of a metered applicator. The Wet topcoated yarn was dried in line by passing it through a hot air oven at 250° C. for about 1.3 seconds, then wound onto a tube. The yarn was in the temperature range of 100° C.-130° C. as it exited the hot tube. The yarns were later heat treated in a Litzler oven at 235° C. for 30 seconds with zero stretch. The yarn was then twisted into 2-ply cords at a twist level of 300 tpm. These cords were embedded in the activated rubber compound B and cured at 170° C. for 10 minutes. N3-L topcoat was applied, fixed in the same way and twisted into cords and cured in rubber compound B as a control.

The peel adhesion results are set forth in Table 18.

TABLE 18

| Topcoat | Peel Adhesion (N) | Peel visual rating |
|---|---|---|
| resorcinol/formaldehyde | 135 | 3.5 |
| resin of F/R molar ratio | | |
| of 0.38 with latex | | |
| N3-L | 144 | 4.0 |

The results show that a simple resorcinol/formaldehyde resin of low F/R molar ratio gives good adhesion. The allyl groups from the triallyl cyanurate (and/or triallyl isocyanurate) in N3 are not necessary for good adhesion.

To the resorcinol/formaldehyde resin ofF/R molar ratio 0.38 prepared above, 3.87 grams of strong ammonia solution was stirred in, giving an ammoniated resin A solution of pH 9.73 and a concentration of 21.35%.

A topcoat was prepared by adding 4.63 grams of Gentac 118 to 81.60 grams of deionized water, with stirring at room temperature. After about ten minutes of stirring, 13.77 grams of ammoniated resin A solution was stirred in. The pH of the topcoat was 9.28 at a concentration of 4.71%. On a dry weight basis, the ratio of resin to latex is 62/38.

A Penacolite R-2170 solution was prepared by adding 14.18 grams of Penacolite R-2170 (a RF resin from Indspec Chemical Corp. Pittsburg Pa. USA) to 27.93 grams of deionized water and 1.19 grams of strong ammonia solution. A clear solution was obtained with a pH of 8.72 and a concentration of 25.87%. This solution was allowed to stand overnight, and then used to prepare the topcoat.

The Penacolite topcoat was prepared by adding 4.63 grams of Gentac 118 to 83.39 grams of deionized water with stirring at room temperature. After about ten minutes of stirring, 11.98 grams of the 25.87% Penacolite solution was stirred in. The pH of the topcoat was 8.71 at a concentration of 4.78%. On a dry weight basis, the ratio of resin to latex is 62/38.

Resin B of molar formaldehyde to resorcinol ratio of 1.20 was prepared by adding 59.48 grams of distilled water to 5.09 grams of resorcinol and 0.73 grams of 10% sodium hydroxide solution. After a clear solution was obtained, the pH was measured as 8.66. 4.7 grams of 37% formaldehyde solution was added and the container sealed. Stirring at room temperature was done for 2 hours, then left to stand in the sealed container overnight. Then 1.33 grams of strong ammonia solution (Fisher Scientific, Pittsburg Pa., USA —about 26° Baume) was stirred in, giving an ammoniated resin solution of pH 9.47 and a concentration of 9.72%. The solution was left overnight before using it in the topcoat.

The topcoat was prepared by adding to 4.63 grams of Gentac 118, 63.49 grams of deionized water with stirring at room temperature. After about ten minutes of stirring, 31.88 grams of resin B solution was stirred in. The pH of the topcoat was 9.28 at a concentration of 5.12%. On a dry weight basis, the ratio of resin to latex is 62/38.

N3-L topcoat was prepared as a control by adding 4.63 grams of Gentac 118 latex to 81.60 grams of deionized water at room temperature. After about ten minutes of stirring, 13.77 grams of Omnova HP resin solution was stirred in. The pH of the topcoat was 8.82 at a concentration of 5.08%. On a dry weight basis, the ratio of resin to latex is 62/38.

Each of the above topcoats was applied to 1440 dtex Type 748 drawn yarn to a target level of 0.8% dry topcoat on yarn by means of two metered applicators. The wet topcoated yarn was dried in line by passing it through a hot air oven at 250° C. for 1.3 seconds, then wound onto a tube. The yarn was in the temperature range of 140° C.-167° C. as it exited the hot tube. The yarns were later heat treated in a Litzler oven at 235° C. for 30 seconds with zero stretch. The yarn was then twisted into 2-ply cords at a twist level of 300 tpm. These cords were embedded in the activated rubber compound B and cured at 170° C. for 10 minutes.

The peel adhesion results are set forth in Table 19.

TABLE 19

| | | | Peel visual |
|---|---|---|---|
| Topcoat | F/R molar ratio | Peel Adhesion (N) | rating |
| Resin A | 0.38 | 127 | 4.5 |
| Penacolite R- | 0.60 | 131 | 4.0 |
| 2170 | | | |
| Resin B | 1.20 | 109 | 3.0 |
| Omnova HP | 0.38 | 118 | 5.0 |
| resin | | | |

The results show that simple resorcinol/formaldehyde-resins ofF/R molar ratio of less than about 1.0 give good adhesions. The allyl groups from the triallyl cyanurate (and/or triallyl isocyanurate) are not necessary for good adhesion.

### Example 15

Another series of phenolic resin compounds, including resorcinol, was prepared to examine the effect of the F/R molar ratio on adhesion. All topcoats had a dry weight ratio of phenolic resin compound to latex of 62/28, and the latex was Genetac 118. The topcoat concentration in water was 5%, and the topcoat was applied at a dry level of 0.8 % to 1440 dtex T748 yarn with 2 metered applicators. The yarn was blown dry with air and kept in a forced ambient air oven for 2 hours. The topcoat was fixed by passing the yarn through a Litzler oven at 235° C. for 30 seconds, and then twisted into 2-ply 300 tpm cords. These cords were embedded in Rubber B and cured at 180° C. for 14 minutes.

The Denabond (Nagase Chemical Ltd., Osaka, Japan) is a phenolic compound prepared by condensing 2 moles of formaldehyde with one mole of p-chlorophenol, and then reacting the product with resorcinol. The resorcinol and Penacolite R-2170 were solubilized with potassium hydroxide.

The adhesion results are set forth in Table 20.

TABLE 20

| | | | | Peel |
|---|---|---|---|---|
| Phenolic | | F/R molar | | Visual |
| compound | pH | ratio | Peel force (N) | Rating |
| Denabond | 10.2 | 0.67 | 122 | 3.5 |
| Penacolite | 8.7 | 0.9 | 132 | 3 |
| Omnova HP | 9.1 | 0.38 | 144 | 4 |
| Resorcinol | 8.5 | 0 | 137 | 4 |

This illustrates that the phenolic compound does not need to be a condensation product with an aldehyde.

### Example 16

N3-L topcoat was prepared as in Example 1, but with more water, making 3.75% concentration.

2950 decitex spun yarn was prepared with 1.0 dry weight percent of an epoxy finish on yarn. The spun yarn was intermingled before winding it onto bobbins. The spun yarn was topcoated with N3-L topcoat from a kiss roll to a target level of 0.8% dry topcoat on yarn. Then the yarn was drawn 2.05 times between draw rolls at room temperature and draw rolls at 150° C., while passing through a hot air oven at 263° C. for 5.4 seconds. The contact time of yarn on the 150° C. rolls was 1.2 seconds. The yarn then passed through an IR channel at 300° C. for 4.8 seconds, then over another set of rolls at room temperature. The yarn was then coated with lubricating finish (based on mineral oil, silicone and an ethoxylated oleyl alcohol) from a 20% concentration emulsion to a target dry finish level on yarn of 0.20%. The 1440 decitex yarn was then wound onto bobbins, and then cabled into 2-ply cords at a twist level of 300 tpm. These cords were embedded in activated rubber compound B and cured at 170° C. for 10 minutes.

The peel adhesion force was only 44 N, with a visual rating of 1.0.

This result shows that it is necessary to first cure the adhesive activated finish to the yarn before reacting it with the topcoat.

### Example 17

N3-L topcoat was prepared as in Example 1, but with more water, making 3.75% concentration.

1440 dtex Type 748 yarn was topcoated to a target level of 0.8% dry topcoat on yarn by means of a kiss roll with a foam roller on top. The target level of topcoat was estimated from the drop in level of the reservoir of the kiss roll tray in a circulating system. The wet topcoated yarn was dried by passing it through a hot air oven at 205° C. at 270° C. for 2.1 seconds. This treatment was about enough to dry the yarn, which was for 2.4 Seconds, over hot rolls at 100° C. for 0.52 second, then through an infra-red oven wound onto a bobbin. The yarn was then taken off the bobbin and heat-set through a hot air oven at 262° C. for 5.4 seconds, contacted over hot rolls at 150° C. for 1.2 seconds, then through an infra-red oven at 300° C. for 4.8 seconds. The yarn was then interlaced with an air jet, then coated with lubricating finish (based on mineral oil, silicone and an ethoxylated oleyl alcohol) from a 20% concentration emulsion to a target dry finish level on yarn of 0.20%. The yarn was then wound onto bobbins, and then cabled into 2-ply cords at a twist level of 300 tpm. These cords were embedded in the activated rubber compound B and cured at 170° C. for 10 minutes.

The peel adhesion force for this sample was 147 N, with a visual rating of 3.5.

The result shows that good adhesion can be obtained with relatively short fixation times of around 12 seconds.

### Example 18

A modified N3-L topcoat was prepared as in Example 1, but with more water, making a 5% concentration and with the inclusion of 0.4% of Zelek NK (Stepan Company, Northfield, Ill., USA ), making the concentration 5.4%. On a dry weight basis, the ratio of resin to latex is 62/38.

2950 decitex spun yarn was prepared with 1.0 dry weight percent of epoxy finish on yarn. The spun yarn was not intermingled before winding it onto bobbins. The yarn was later taken off the bobbins and drawn and heat-set and topcoated with the modified N3-L topcoat and cured all in one pass to make 1440 decitex rubber-ready drawn yarn. Firstly the spun yarn was drawn 2.05 times between draw rolls at room temperature and draw rolls at 100° C., while passing through a hot air oven at 263° C. for about 2.7 seconds. The contact time of yarn on the 100° C. rolls was 0.6 seconds. The modified N3L topcoat was then applied from a kiss roll to a measured level of 1.08% dry topcoat on yarn. The yarn then passed over hot rolls at 220° C. with a contact time of 0.45 seconds and through an IR channel at 290° C. for 2.4 seconds, then over another set of rolls at room temperature. The yarn was then coated with lubricating finish (based on mineral oil, silicone and an ethoxylated oleyl alcohol) from a 20% concentration emulsion to a target dry finish level on yarn of 0.20%. The yarn was then wound onto bobbins, then cabled into 2-ply cords at a twist level of 300 tpm. After eight days from topcoating & fixation, these cords were embedded in activated rubber compound B and cured at 170° C. for 10 minutes.

The peel adhesion force for this cord was 169 N, with a visual rating of 5.0.

The modified N3-L topcoat containing Zelek NK reduced the amount of deposits on the kiss roll applicator, as assessed visually, when compared to N3-L topcoat without Zelek NK.

The results show that good adhesion can be obtained with a single pass process from spun yarn in a relatively short total cure time of around six seconds.

### Example 19

5% N3-L topcoat was prepared by adding 9.27 grains of Gentac 118 latex to 163.18 grams of deionized water at room temperature. After about ten minutes of stirring, 27.56 grams of N3 resin solution was stirred in. The ratio of resin to latex is 62/38.

1656 denier high tenacity rayon yarn (Acordis) was topcoated with this topcoat to a target level of dry topcoat on yarn of 0.8% using two metered finish applicators. The wet topcoated yarn was dried in line by passing it through a hot air oven at 250° C. for 1.6 seconds, then wound onto a tube. The yarn was in the temperature range of 130° C.-140° C. as it exited the hot tube. The topcoated rayon was then heat treated in a Litzler oven under two conditions: at 235° C. for 30 seconds with zero stretch and at 248.9° C. for 30 seconds with zero stretch. The yarns were then twisted into 2-ply cords at a twist level of 265 tpm. These cords were embedded in activated rubber compound B and cured at 170° C. for 10 minutes.

A T-748 drawn polyester yarn was topcoated with this topcoat to a target level of dry topcoat on yarn of 0.8% using two metered finish applicators. The wet topcoated yarn was dried in line bypassing it through a hot air oven at 250° C. for 1.5 seconds, then wound onto a tube. The yarn was in the temperature range of 130° C.-140° C. as it exited the hot tube. The topcoated polyester yarn was later heat treated in a Litzler oven at 235° C. for 30 seconds with zero stretch. The yarn was then twisted into 2-ply cord at a twist level of 300 tpm. The cord was embedded in activated rubber compound B and cured at 170° C. for 10 minutes.

A 1260 denier nylon 6.6 (Monsanto) was topcoated with 5% N3-L topcoat to a target level of dry topcoat on yarn of 0.8% using two metered finish applicators. The wet topcoated yarn was dried in line by passing it through a hot air oven at 250° C. for 1.4 seconds, then wound onto a tube. The yarn was in the temperature range of 100° C.-150° C. as it exited the hot tube. The topcoated nylon was later heat treated in a Litzler oven at 235° C. for 30 seconds with zero stretch. The yarn was then twisted into 2-ply cord at a twist level of 304 tpm. The cord was embedded in activated rubber compound B and cured at 170° C. for 10 minutes.

The peel adhesion results are set forth in Table 21.

TABLE 21

| | | Peel visual |
|---|---|---|
| Yarn type | Peel Adhesion (N) | rating |
| Rayon with 235° C. Litzler heat | 109 | 2.0 |
| treatment | | |
| Rayon with 249° C. Litzler heat | 96 | 2.0 |
| treatment | | |
| T-748 polyester | 145 | 3.0 |
| Nylon 6.6 | 62 | 1.0 |

The results show that neither non-adhesive activated rayon nor nylon 6.6 gives good adhesions with this topcoat under these conditions. It is apparent that an adhesive activated yarn is required for this invention.

### Example 20

The N3-L topcoated yarn from Example 17 was cabled into a 2 ply cord with a twist level of 300 tpm. The N3-L topcoated cord was woven into a fabric (105 epdm) and the fabric calendered with activated rubber compound B. This was used as the carcass for tires, and after the sidewall and tread rubbers were applied the tires were cured at 190° C. for 20 minutes. As a control, the uncoated T748 yarn was cabled into 2 ply cords at a twist level of 370 tpm. The control cord was dipped with a standard RFL resin at a 5% dip pick up and cured. This control cord was woven into the same construction (105 epdm) and calendered with rubber compound A. This was used as the carcass for tires, and after the sidewall and tread rubbers were applied the tires were cured at 190° C. for 10 minutes.

Two tire builds were made from these fabrics:
225/70 R 15 112 R, 2-ply carcass with 6 ply belt (2 plies each of polyester, steel and nylon)
185/65 R 14 86 H, 1-ply carcass with 4 ply belt (1 ply polyester, 2 plies steel and 1 ply nylon).

Endurance tests were made according with US regulation FMVSS 109. High speed tests were made according with ECE R30 and DIN for passenger car tires on a 1.7 meter drum. Plunger tests were made according to FMVSS 119. The results are set forth in Table 22.

TABLE 22

| | Endur- | | | | |
|---|---|---|---|---|---|
| | ance, | | | | |
| | hours* | | | Plunger, daN | |
| | N3-L | High speed, minutes | | N3-L | RFL |
| Tire Size | topcoat | N3-L topcoat | RFL dip | topcoat | dip |
| 225/70 | 47 | 30 @ 170 km/h | 30 @ 170 km/h | 68 | 68 |
| R115 | | | | | |
| 185/65 | 1000 | 5 @ 270 km/hr | 10 @ 260 km/h | — | — |
| R14 | | | | | |

*No failure

The lower twist level cord topcoated with N3-L gave comparable tire test performance as the higher twist level cord with standard RFL dip.

Thus according to the present invention, there has been disclosed a method for improving direct adhesion between an adhesive activated textile reinforcing material and an activated rubber. Those skilled in the art realize many alternatives, advantages and variations will be apparent in light of the foregoing description. Accordingly the present invention is intended to embrace all alternative, advantages and modifications as fall within the spirit and scope of the appended claims.

1. A method to achieve direct adhesion between an adhesive activated textile reinforcing material and an activated rubber comprising the steps of
(A) applying a topcoat composition to the activated textile reinforcing material;
(B) fixing the topcoat composition to the material obtained from step (A);
(C) embedding the material from step (B) in the activated rubber; and
(D) curing the rubber containing the textile reinforcing material obtained from step (C) at a temperature and for a time sufficient to cure said rubber.

2. The method of claim 1 wherein the textile reinforcing material is selected from the group consisting of polyester, rayon, polyamide and aramid.

3. The method of claim 1 wherein the textile reinforcing material is polyester.

4. The method of claim 1 wherein the topcoat composition comprises
(i) at least one hydroxyl aromatic compound having at least two hydroxyl groups, or
a phenolic resin compound obtainable from a hydroxyl aromatic compound having at least one hydroxyl group; and
(ii) at least one diene polymer.

5. The method according to claim 1, wherein the topcoat composition is dissolved in a suitable solvent and applied to the textile reinforcing material.

6. The method of claim 5, wherein the suitable solvent comprises water.

7. The method of claim 4, wherein the phenolic resin compound is chosen from the group comprising condensation products of the hydroxyl aromatic compounds condensed with an aldehyde or a ketone with an aldehyde/ketone to hydroxyl aromatic compound molar ratio of less than 1.0.

8. The method of claim 4, wherein the diene polymer is present in the topcoat composition in the form of a latex.

9. The method of claim 1, wherein the topcoat composition is fixed to said textile reinforcing material by exposure to a temperature in the range of from about 20° C. to about 250° C., preferably from about 110° C. to 240° C., most preferably from about 215° C. to 235° C.

10. The method of claim 1, wherein the rubber is selected from the group consisting of diene rubbers, diene/alpha-olefin rubbers, ethylene/propylene rubbers and ethylene/alpha-olefin/diene rubbers.

11. The method of claim 1, wherein the rubber is cured at a temperature of from about 140° C. to 220° C., preferably from about 160° C. to 200° C., most preferably from about 170° C. to 180° C.

12. The method of claim 1, wherein the topcoat composition as applied comprises
(i) a phenolic resin compound obtainable by the reaction of a hydroxyl aromatic compound (R) with 2 or more aromatic hydroxyl groups containing between about 5, preferably 6 and 14, preferably 10 carbon atoms with an aldehyde containing between about 1 and about 12 carbon atoms, preferably between about 1 and about 7 carbon atoms or a ketone containing between about 3 and about 8 or about 13 carbon atoms, preferably between about 3 and about 6 carbon atoms (F) at a F/R molar ratio of less than 1.0; and
(ii) a diene latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

13. The method of claim 1, wherein the topcoat composition as applied comprises
(i) a phenolic resin compound having a solids content from about 10 to about 100%, preferably from about 15 to about 80%, most preferably from about 20% obtainable by the reaction of resorcinol (R) with formaldehyde (F) at a F/R molar ratio of less than 1.0; and
(ii) a latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

14. The method of claim 12 or 13, wherein the F/R molar ratio is in the range of about 0.2 to about 0.9, preferably from about 0.3 to 0.6, and most preferably about 0.4.

15. The method of claim 1, wherein the topcoat composition as applied comprises
(i) a phenolic resin compound obtainable by the reaction of triallyl cyanurate and/or triallyl isocyanurate with a hydroxyl aromatic compound with 2 or more aromatic hydroxyl groups containing between about 5, preferably 6 and 14, preferably 10 carbon atoms and then reacting the resulting product (R) with an aldehyde containing between about 1 and about 12 carbon atoms, preferably between about 1 and about 7 carbon atoms or a ketone containing between about 3 and about 8 or about 13 carbon atoms, preferably between about 3 and about 6 carbon atoms (F) and solubilizing the resulting product in an aqueous basic solution at a F/R molar ratio of less than 1.0; and
(ii) a diene latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

16. The method of claim 1, wherein the topcoat composition as applied comprises
(i) a phenolic resin compound having a solids content from about 10 to about 100%, preferably from about 15 to about 80%, most preferably from about 20% obtainable by the reaction of triallyl cyanurate and/or triallyl isocyanurate and resorcinol (R), then reacting the resulting product with formaldehyde (F) and solubilizing it in an aqueous basic solution with a F/R molar ratio of less than 1; and
(ii) a latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

17. The method of claim 15 or 16, wherein the F/R molar ratio is in the range of about 0.2 to about 0.7, preferably from about 0.3 to 0.6, and most preferably about 0.4.

18. The method of claim 1, wherein the topcoat is present in an amount of from about 0.1 to about 3% by weight, preferably from about 0.2 to about 2% by weight, and most preferably from about 0.4 to about 1.5% by weight, based on the weight of the dry coated textile reinforcing material.

19. The method of claim 1, wherein the textile reinforcing material is selected from the group consisting of filaments, yarns, cords, fabrics, films, tapes and any combination thereof.

20. The method of claim 1, wherein the topcoat composition is applied to the textile reinforcing material during the process of making the textile reinforcing material.

21. The method of claim 1, wherein the rubber contains an RF-adhesion system of resorcinol and resorcinol-formaldehyde precondensate, a methylene donor and active silica.

22. An topcoat composition for imparting adhesion to textile reinforcing materials said composition having no aldehyde and comprising:
(i) at least one hydroxyl aromatic compound having at least two hydroxyl groups, or
a phenolic resin compound obtainable from a hydroxyl aromatic compound having at least one hydroxyl group; and
(ii) at least one diene polymer.

23. The topcoat composition of claim 22 being aqueous.

24. An activated textile reinforcing material obtainable by a method comprising the steps of
(A) applying a topcoat composition to an activated textile reinforcing material; and
(B) fixing the topcoat composition to the material obtained from step (A).

25. The material of claim 32 wherein the textile reinforcing material is selected from the group of polyester, rayon, polyamide and aramid.

26. The material of claim 32 wherein the textile reinforcing material is polyester.

27. The material of claim 32, wherein the topcoat composition is dissolved in a suitable solvent and applied to the textile reinforcing material.

28. The material of claim 35, wherein the suitable solvent comprises water.

29. The material of claim 32, wherein the textile reinforcing material is selected from the group consisting of filaments, yarns, cords, fabrics, films, tapes, and any combination thereof.

30. The material of claim 32, wherein the topcoat composition is applied to the textile reinforcing material during the process of making the textile reinforcing material.

31. The material of claim 32 wherein the topcoat composition comprises
(i) at least one hydroxyl aromatic compound having at least two hydroxyl groups, or
a phenolic resin compound obtainable from a hydroxyl aromatic compound having at least one hydroxyl group; and
(ii) at least one diene polymer.

32. The material of claim 32 wherein the topcoat composition is an aqueous composition.

33. The material of claim 32 wherein, after having applied the topcoat to the textile reinforcing material, the topcoated textile reinforcing material is exposed to a temperature in the range of from about 20° C. to about 250° C., preferably from about 110° C. to 240° C., most preferably from about 215° C. to 235° C.

34. The material of claim 32 wherein the topcoat composition comprises
(i) a phenolic resin compound obtainable by the reaction of a hydroxyl aromatic compound (R) with 2 or more aromatic hydroxyl groups containing between about 5, preferably 6 and 14, preferably 10 carbon atoms with an aldehyde containing between about 1 and about 12 carbon atoms, preferably between about 1 and about 7 carbon atoms or a ketone containing between about 3 and about 8 or about 13 carbon atoms, preferably between about 3 and about 6 carbon atoms (F) at a F/R molar ratio of less than 1.0; and
(ii) a latex having a solids content from about 30 to about 50%, preferably about 35 to 45%, most preferably about 40%,
wherein the dry weight-ratio of resin (i) to latex (ii) is from about 50/50 to about 80/20,based on the total dry weight of (i) and (ii).

35. The material of claim 32 wherein the topcoat composition comprises
(i) a phenolic resin compound having a solids content from about 10 to about 100%, preferably from about 15 to about 80%, most preferably from about 20% obtainable by the reaction resorcinol (R) with formaldehyde (F) at a F/R molar ratio of less than about 1.0; and
(ii) a latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

36. The material of claim 34 or 35 wherein the F/R molar ratio of the resin is in the range of about 0.2 to about 0.9, preferably from about 0.3 to 0.6, and most preferably about 0.4.

37. The material of claim 32 wherein the topcoat composition comprises
(i) a phenolic resin compound obtainable by the reaction of triallyl cyanurate and/or triallyl isocyanurate with a hydroxyl aromatic compound with 2 or more aromatic hydroxyl groups containing between about 5, preferably 6 and 14, preferably 10 carbon atoms and then reacting the resulting product (R) with an aldehyde containing between about 1 and about 12 carbon atoms, preferably between about 1 and about 7 carbon atoms or a ketone containing between about 3 and about 8 or about 13 carbon atoms, preferably between about 3 and about 6 carbon atoms (F) and solubilizing the resulting product in an aqueous basic solution at a F/R molar ratio of less than 1.0; and
(ii) a latex having a solids content from about 30 to about 50%, preferably about 35 to 45%, most preferably about 40%,
wherein the dry weight-ratio of resin (i) to latex (ii) is from about 50/50to about 80/20, based on the total dry weight of (i) and (ii).

38. The material of claim 32 wherein the topcoat composition comprises
(i) a phenolic resin compound having a solids content from about 10 to about 100%, preferably from about 15 to about 80%, most preferably from about 20% obtainable by the reaction of triallyl cyanurate and/or triallyl isocyanurate and resorcinol (R), then reacting the resulting product with formaldehyde (F) and solubilizing it in an aqueous basic solution with a F/R molar ratio of less than about 1; and
(ii) a latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

39. The material of claim 37 or 38, wherein the F/R molar ratio of the resin is in the range of about 0.2 to about 0.7, preferably from about 0.3 to 0.6, and most preferably about 0.4.

40. The material of claim 32 wherein the topcoat composition is present in an amount of from about 0.1 to about 3% by weight, preferably from about 0.2 to about 2% by weight, and most preferably from about 0.4 to about 1.5% by weight, based on the weight of the dry coated adhesive activated textile reinforcing material.

41. A reinforced rubber article obtainable by a method comprising the steps of
(A) applying an topcoat composition to a an activated textile reinforcing material;
(B) fixing an topcoat composition to the material obtained from step (A);
(C) embedding the material from step (B) in an activated rubber; and
(D) curing the rubber containing the reinforcing material obtained from step (C) at a temperature and for a time sufficient to cure said rubber.

42. The article of claim 49 wherein the textile reinforcing material is selected from the group consisting of polyester, rayon, polyamide and aramid.

43. The article of claim 49 wherein the textile reinforcing material is polyester.

44. The article of claim 49 wherein the topcoat composition comprises
(i) at least one hydroxyl aromatic compound having at least two hydroxyl groups, or
a phenolic resin compound obtainable from a hydroxyl aromatic compound having at least one hydroxyl group; and
(ii) at least one diene polymer.

45. The article according to claim 49, wherein the topcoat composition is dissolved in a suitable solvent and applied to the textile reinforcing material.

46. The article of claim 53, wherein the suitable solvent comprises water.

47. The article of claim 52, wherein the phenolic resin compound is chosen from the group comprising condensation products of the hydroxyl aromatic compounds condensed with an aldehyde or a ketone with an aldehyde/ketone to hydroxyl aromatic compound molar ratio of less than about 1.0.

48. The article of claim 42, wherein the diene polymer is present in the topcoat in the form of a latex.

49. The article of claim 49, wherein the topcoat composition is fixed to said textile reinforcing material by exposure to a temperature in the range of from about 20° C. to about 250° C., preferably from about 110° C. to 240° C., most preferably from about 215° C. to 235° C.

50. The article of claim 49, wherein the rubber is selected from the group consisting of diene rubbers, diene/alpha-olefin rubbers, ethylene/propylene rubbers and ethylene/alpha-olefin/diene rubbers.

51. The article of claim 49, wherein the rubber is cured at a temperature, of from about 140° C. to 220° C., preferably from about 160° C. to 200° C., most preferably from about 170° C. to 180° C.

52. The article of claim 49, wherein the topcoat composition applied comprises
(i) a phenolic resin compound obtainable by the reaction of a hydroxyl aromatic compound (R) with 2 or more aromatic hydroxyl groups containing between about 5, preferably 6 and 14, preferably 10 carbon atoms with an aldehyde containing between about 1 and about 12 carbon atoms, preferably between about 1 and about 7 carbon atoms or a ketone containing between about 3 and about 8 or about 13 carbon atoms, preferably between about 3 and about 6 carbon atoms (F) at a F/R molar ratio of less than 1.0; and
(ii) a latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

53. The article of claim 49, wherein the topcoat composition applied comprises
(i) a phenolic resin compound having a solids content from about 10 to about 100%, preferably from about 15 to about 80%, most preferably from about 20% obtainable by the reaction of resorcinol (R) with formaldehyde (F) at a F/R molar ratio of less than about 1.0; and
(ii) a latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

54. The article of claim 52 or 53, wherein the F/R molar ratio is in the range of about 0.2 to about 0.9, preferably from about 0.3 to 0.6, and most preferably about 0.4.

55. The article of claim 49, wherein the topcoat composition applied comprises
(i) a phenolic resin compound obtainable by the reaction of triallyl cyanurate and/or triallyl isocyanurate with a hydroxyl aromatic compound with 2 or more aromatic hydroxyl groups containing between about 5, preferably 6 and 14, preferably 10 carbon atoms and then reacting the resulting product (R) with an aldehyde containing between about 1 and about 12 carbon atoms, preferably between about 1 and about 7 carbon atoms or a ketone containing between about 3 and about 8 or about 13 carbon atoms, preferably between about 3 and about 6 carbon atoms (F) and solubilizing the resulting product in an aqueous basic solution at a F/R molar ratio of less than 1.0; and
(ii) a latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

56. The article of claim 49, wherein the topcoat composition applied comprises
(i) a phenolic resin compound having a solids content from about 10 to about 100%, preferably from about 15 to about 80%, most preferably from about 20% obtainable by the reaction of triallyl cyanurate and/or triallyl cyanurate and resorcinol (R), then reacting the resulting product with formaldehyde (F) and solubilizing it in an aqueous basic solution with a F/R molar ratio of less than about 1; and
(ii) a latex having a solids content from about 30 to about 50%, preferably about 35 to 45%, most preferably about 40%,
wherein the dry weight-ratio of resin (i) to latex (ii) is from about 50/50 to about 80/20, based on the total dry weight of (i) and (ii).

57. The article of claim 55 or 56, wherein the F/R molar ratio is in the range of about 0.2 to about 0.7, preferably from about 0.3 to 0.6, and most preferably about 0.4.

58. The article of claim 49, wherein the topcoat is present in an amount of from about 0.1 to about 3% by weight, preferably from about 0.2 to about 2% by weight, and most preferably from about 0.4 to about 1.5% by weight, based on the weight of the dry coated textile reinforcing material.

59. The article of claim 49, wherein the textile reinforcing material is selected from the group consisting of filaments, yarns, cords, fabrics, films, tapes, and any combination thereof.

60. The article of claim 49, wherein the topcoat composition is applied to the textile reinforcing material during the process of making the textile reinforcing material.

61. The article of claim 49, having improved dynamic fatigue properties.

62. A tire, hose, V-belt or conveyor belt obtainable from the article of anyone of claims 41 to 61.
